(19) United States
(12) Patent Application Publication
(10) Pub. No.: US 2010/0118551 A1
(43) Pub. Date: May 13, 2010

(54) Illuminating device and light emitting unit

(76) Inventor: James Ywh-Ren Jeng, Irvine, CA (US)

Correspondence Address: BACON & THOMAS, PLLC, 625 SLATERS LANE, FOURTH FLOOR, ALEXANDRIA, VA, 22314-1176, US

(21) Appl. No.: 12/292,066

(22) Filed: Nov. 12, 2008

(51) Int. Cl. F21V 11/00

(52) U.S. Cl. 362/353

(57) ABSTRACT

An illuminating device comprising a lampshade, an electric connector and a light emitting unit, in which the lampshade has therein a receiving space for receiving the light emitting unit, and for fixing the electric connector on its rear side to connect a pair of electric power lines, the illuminating device is characterized in that: the light emitting unit includes two plug-in pins, a front half part of each plug-in pin is an arched elastic buffering portion, and a rear half part of the plug-in pin is a fixing portion; when the two plug-in pins are fixed onto the electric connector, the elastic buffering portions can absorb outwardly stretching deforming forces exerted on the plug-in pins, thus avoid breaking of the plug-in pins in bearing forces, superiority of production can be effectively increased, and the life of use of the illuminating device can be elongated.

### BACKGROUND OF THE INVENTION

1. Field of the Invention

The present invention relates to an illuminating device; and especially to an illuminating device with high superiority of production, the illuminating device can render an illuminating to get elongated life of use.

2. Description of the Prior Art

A normal conventional illuminating device has a plug-in pin of a light emitting unit (such as an LED) connected by welding with an electric power line, in order to give the light emitting unit electric power source to emit light; however in use, changing of the light emitting unit is quite in convenient, there have been illuminating devices developed in the markets for the convenience of detaching and changing the light emitting unit without welding.

Such a illuminating device is provided in a lampshade having a receiving space with an electrically connecting device, the electrically connecting device has a light emitting unit, and is provided with a pair of receiving holes each having therein an electrically conductive member, one end of each electrically conductive member is connected with an electric power line, while the other end is used for insertion connecting of a plug-in pin of the light emitting unit, in order that the electric power line can provide electric power for the light emitting unit via the electrically conductive member.

The electrically connecting device and the electrically conductive member are provided radially with a plurality of fixing holes mutually opposite to, being used for screwing in of screws to fix the electric power line, the plug-in pin of the light emitting unit and the electrically conductive member onto the electrically connecting device.

The illuminating device can have the light emitting unit changed conveniently, and can be electrically connected with the electric power line without welding. However, the plug-in pin of the light emitting unit used on the illuminating device is in a linear shape, a rotative screw is needed to clamp the plug-in pins in installing, thereby when in locking a second one of the plug-in pins after the first one of the plug-in pins is locked, an outwardly stretching deforming force will be created in locking the second plug-in pin because the first plug-in pin has been locked, so that the plug-in pins of the light emitting unit are subjected to deforming and breaking when being borne with a force, and the light emitting unit is damaged and discarded. Meantime problems of assembling and repairing are induced.

In view of these, the inventor of the present invention studied and developed an illuminating device and a light emitting unit that can avoid the defect of easy deforming and breaking of the plug-in pins of the light emitting unit when in assembling, thereby superiority of production can be effectively increased, and the life of use of the light emitting unit can be elongated.

### SUMMARY OF THE INVENTION

The primary object of the present invention is to provide an illuminating device and a light emitting unit that is easy for assembling and can avoid the defect of easy deforming and breaking of plug-in pins of the light emitting unit when in assembling, thereby superiority of production can be effectively increased, and the life of use of the light emitting unit can be elongated.

For achieving the above object, the present invention is composed of a lampshade, an electric connector and a light emitting unit, in which the lampshade has therein a receiving space for receiving the light emitting unit, and for fixing the electric connector on its rear side to connect a pair of electric power lines, the present invention is characterized in that:

The light emitting unit is composed of a light emitting part and two plug-in pins which includes a first plug-in pin and a second plug-in pin, a front half part of each of the first and the second plug-in pins is an arched elastic buffering portion, and a rear half part of each of the plug-in pins is a fixing portion for fixing. The fixing portion is electrically connected with the electric connector, in order that the electric connector can provide electric power for light emitting of a light emitting part via the first and the second plug-in pins; The electric connector is provided in opposition to the light emitting unit with an insertion connecting portion for insertion of the first and the second plug-in pins, and is provided on its two lateral sides in opposition to the fixing portions of the plug-in pins with fixing holes for inserting and fixing of screws therein.

When the screws are used to fix the first plug-in pin, by virtue that they are rotatively screwed in, they render the first plug-in pin to bear outwardly stretching deforming forces, this will change the original angular of the first plug-in pin relative to the light emitting part, meantime will change the angle between the first and the second plug-in pins.

However, by virtue that the elastic buffering portions of the first and the second plug-in pins are each in an arch shape and are elastic, when in fixing the second plug-in pin, the elastic buffering portions of the first and the second plug-in pins can absorb the outwardly stretching deforming forces exerted by the screws on the second plug-in pin being fixed, so that both the first and the second plug-in pin will not be deformed and broken.

When in practicing, the lampshade is composed of an upper cover, a bottom seat and a connecting member for fixing the upper cover and the bottom seat, the upper cover and the bottom seat is formed therebetween a receiving space for receiving the light emitting unit; the upper cover is provided on its front side with a front engaging portion, and on its rear side with a rear engaging portion, and at its center with a transparent sheet for radiating out of light from the light emitting unit.

The bottom seat has a lug extending out of the front side of it, the lug is excavated to form therein a screw hole for screwing in of a screw, the bottom seat is excavated on its rear side to form a through hole, the upper edge of the rear side has a rear engaging piece extending upwards and is curved for pressing downwards the rear engaging portion on the upper cover to fix the upper cover onto the bottom seat.

The connecting member has a curved shape and is elastic, one end of it is used for engaging an engaging portion below the lug, the other end of it is a pressing portion for press engaging the front engaging portion of the upper cover, the pressing portion is provided with a screw hole for screwing in of a screw, the screw hole is in cooperation with the screw hole on the lug, thereby the screw can lock the upper cover and the bottom seat together.

The electric connector, in addition to being provided on its front side with the insertion connecting portion for inserting of the light emitting unit, and being provided on its two lateral sides with the fixing hole for locking the light emitting unit with the abovementioned screws, is provided on its top with a fixedly connecting portion, the fixedly connecting portion has a fixedly connecting hole for locking therein with a screw, hence the connector can be fixed in the through hole of the bottom seat. And more, the connector is provided on the rear of the insertion connecting portion with a pair of receiving holes, each receiving hole is provided with an electrically conductive member, each electrically conductive member is electrically connected with an electric power line, and one plug-in pin of the light emitting unit, so that the electric power line can provide electric power for light emitting of the light emitting unit. When in practicing, the electrically conductive members each can have a cylindrical shape, the elastic buffering portions of the first and the second plug-in pins on the light emitting unit can be in the shape of “U” or “V”.

As compared with the conventional technique, designing of the elastic buffering portions on the light emitting unit of the present invention can absorb the outwardly stretching deforming forces exerted by screws in fixing the first and the second plug-in pins, this can avoid breaking of the first and the second plug-in pins in bearing forces, thus superiority of production can be effectively increased, rate for repairing can be lowered, and the life of use of the light emitting unit can be elongated. And designing of connecting by engaging on the housing of the lampshade and the bottom seat of the lampshade even allows fast assembling and disassembling, thus time for assembling and repairing can be reduced, and convenience of use can be increased.

The present invention will be apparent after reading the detailed description of the preferred embodiment thereof in reference to the accompanying drawings.

### BRIEF DESCRIPTION OF THE DRAWINGS

FIG. 1 is a perspective view of the present invention;

FIG. 2 is an exploded perspective view of the present invention;

FIG. 3 is an exploded perspective view showing a light emitting unit and an electric connector;

FIG. 4 is a schematic view showing insertion connecting of the light emitting unit with the electric connector;

FIG. 5 is a partial sectional view of the present invention;

FIG. 6 is another partial sectional view of the present invention.

### DETAILED DESCRIPTION OF THE PREFERRED EMBODIMENT

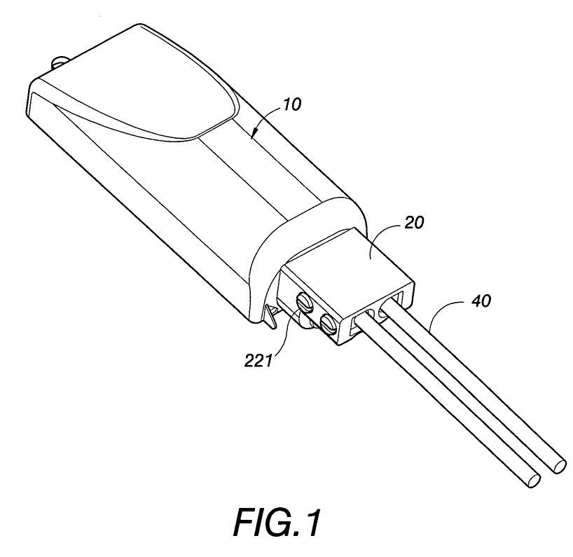

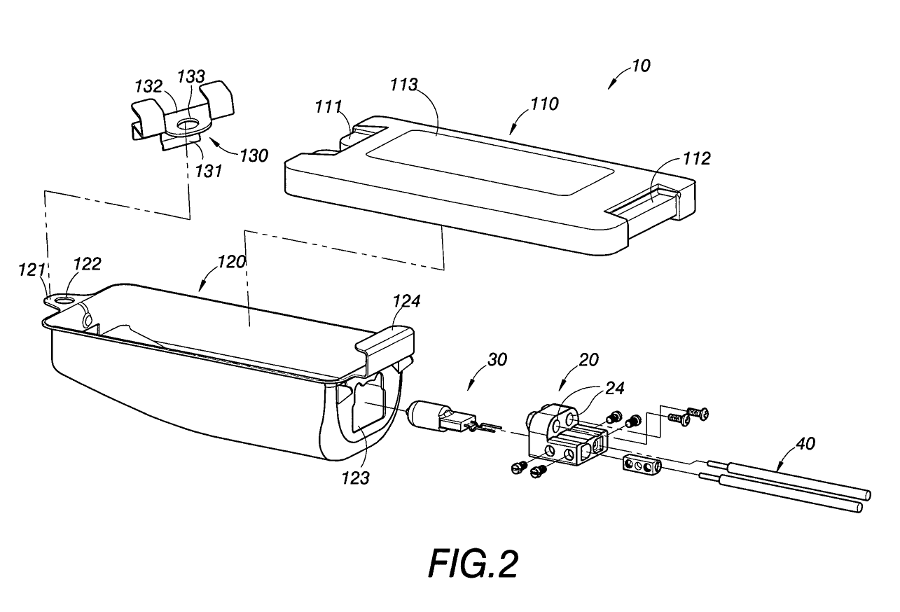

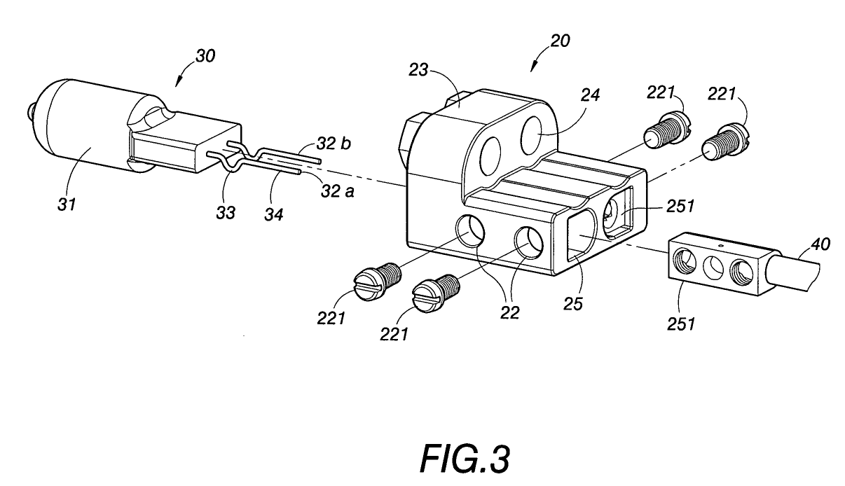

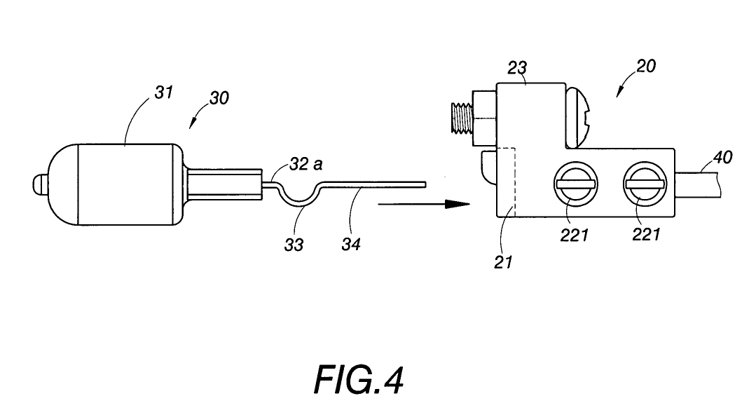

Referring firstly to FIGS. 1-3, an illuminating device of the present invention is composed of a lampshade 10, an electric connector 20 and a light emitting unit 30, in which the lampshade 10 has therein a receiving space for receiving the light emitting unit 30, the light emitting unit 30 has two plug-in pins 32a, 32b electrically connected with the electric connector 20; the front end of the electric connector 20 is fixed on the rear side of the lampshade 10, and the rear end of the electric connector 20 is connected with a pair of electric power lines 40, so that the light emitting unit 30 can be connected to an electric power supply via the electric connector 20.

Wherein, as shown in FIGS. 2-4, the light emitting unit 30 is composed of a light emitting part 31 and the two plug-in pins which include a first and a second plug-in pin 32a, 32b, a front half part of each of the first and the second plug-in pins 32a, 32b is an arched elastic buffering portion 33, and a rear half part of each of the plug-in pins 32a, 32b is a fixing portion 34 for fixing. The fixing portion 34 is electrically connected with the electric connector 20, in order that the electric connector 20 can provide electric power for light emitting of the light emitting part 31 via the first and the second plug-in pins 32a, 32b; The electric connector 20 is provided in opposition to the light emitting unit 30 with an insertion connecting portion 21 for insertion of the first and the second plug-in pins 32a, 32b, and is provided on its two lateral sides with fixing holes 22 being provided on the fixing portions 34 respectively of the first and the second plug-in pins 32a, 32b for inserting and fixing of screws 221 therein.

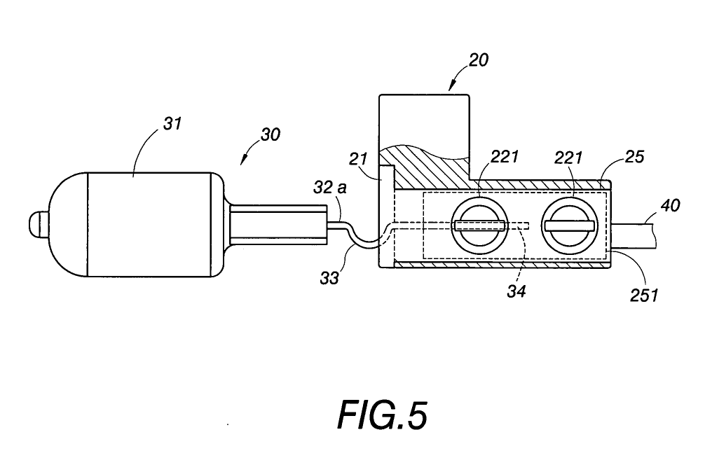

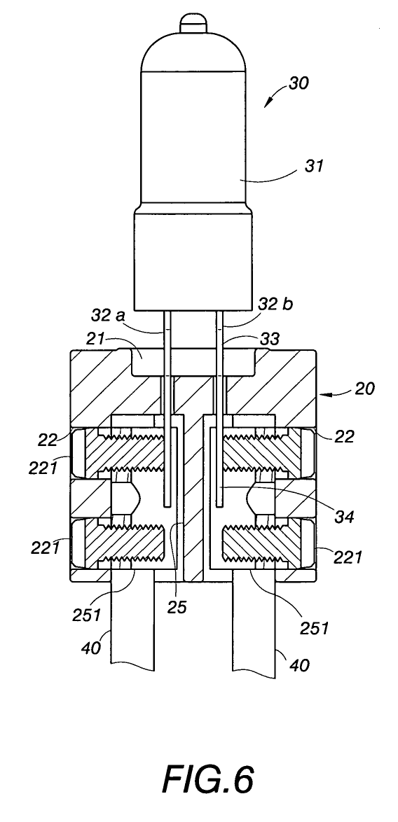

As shown in FIGS. 5 and 6, when the screws 221 are used to fix the first plug-in pin 32a, by virtue that they are screwed in by the mode of rotating, they render the first plug-in pin 32a will to bear outwardly stretching deforming forces, this will change the original angular of the first plug-in pin 32a relative to the light emitting part 31, meantime will change the angle between the first and the second plug-in pins 32a, 32b.

However, by virtue that the elastic buffering portions 33 of the first and the second plug-in pins 32a, 32b are each in an arch shape and are elastic, when in fixing the second plug-in pin 32b, the elastic buffering portions 33 of the first and the second plug-in pins 32a, 32b can absorb the outwardly stretching deforming forces exerted by the screws 221 on the second plug-in pin 32b being fixed, so that the second plug-in pin 32b will not be deformed and broken.

When in practicing, as shown in FIGS. 2-4,the lampshade 10 is composed of an upper cover 110, a bottom seat 120 and a connecting member 130 for fixing the upper cover 110 and the bottom seat 120, the upper cover 110 and the bottom seat 120 is formed therebetween a receiving space for receiving the light emitting unit 30; the upper cover 110 is provided on its front side with a front engaging portion 111, and on its rear side with a rear engaging portion 112, and at its center with a transparent sheet 113 for radiating out of light from the light emitting unit 30.

The bottom seat 120 has a lug 121 extending out of the front side of it, the lug 121 is excavated to form therein a screw hole 122 for screwing in of a screw, the bottom seat 120 is excavated on its rear side to form a through hole 123, the upper edge of the rear side has a rear engaging piece 124 extending upwards and is curved for pressing downwards the rear engaging portion 112 on the upper cover 110 to fix the upper cover 110 onto the bottom seat 120.

The connecting member 130 has a curved shape and is elastic, one end of it is used for engaging an engaging portion 131 below the lug 121, the other end of it is a pressing portion 132 for press engaging the front engaging portion 111 of the upper cover 110, the pressing portion 132 is provided with a screw hole 133 for screwing in of a screw, the screw hole 133 is in cooperation with the screw hole 121 on the lug 133, thereby the screw can lock the upper cover 110 and the bottom seat 120 together.

The electric connector 20, in addition to being provided on its front side with the insertion connecting portion 21 for inserting of the light emitting unit 30, and being provided on its two lateral sides with the fixing hole 22 for locking the light emitting unit 30 with the screws 221, is provided on its top with a fixedly connecting portion 23, the fixedly connecting portion 23 has a fixedly connecting hole 24 for locking therein with a screw, hence the electric connector 20 can be fixed in the through hole 123 of the bottom seat 120. And more, the electric connector 20 is provided on the rear of the insertion connecting portion 21 with a pair of receiving holes 25, each receiving hole 25 is provided with an electrically conductive member 251, each electrically conductive member 251 is electrically connected with an electric power line 40, and one plug-in pin of the light emitting unit 30, so that the electric power line 40 can provide electric power for light emitting of the light emitting unit 30. When in practicing, the electrically conductive members 251 each can have a cylindrical shape, the elastic buffering portions 33 of the first and the second plug-in pins 32a, 32b on the light emitting unit 30 can be in the shape of “U” or “V”.

The names of the members and the drawings for the present invention are only for illustrating preferred embodiments of the present invention, and not for giving any limitation to the scope of the present invention. It will be apparent to those skilled in this art that various equivalent modifications or changes without departing from the spirit, scope and characteristic of this invention shall fall within the scope of the appended claims and are intended to form part of this invention.

1. An illuminating device comprising a lampshade, an electric connector and a light emitting unit, in which said lampshade has therein a receiving space for receiving said light emitting unit, and for fixing said electric connector on its rear side to connect a pair of electric power lines, said illuminating device is characterized in that:
said light emitting unit includes two plug-in pins, a front half part of each of said plug-in pins is an arched elastic buffering portion, and a rear half part of each of said plug-in pins is a fixing portion for fixing; said electric connector is provided in opposition to said light emitting unit with an insertion connecting portion for insertion of said two plug-in pins, and is provided on its two lateral sides in opposition to said fixing portions of said plug-in pins with fixing holes for inserting and fixing of screws therein, said elastic buffering portions are adapted to absorbing outwardly stretching deforming forces exerted by said screws in fixing said plug-in pins, thus avoid breaking of said plug-in pins in bearing forces.

2. The illuminating device as in claim 1, wherein:
said electric connector is provided on a rear side of said insertion connecting portion with a pair of receiving holes, each of said receiving holes is provided with an electrically conductive member being electrically connected with an electric power line and one of said plug-in pins of said light emitting unit.

3. The illuminating device as in claim 2, wherein:
said electrically conductive members each has a cylindrical shape.

4. The illuminating device as in claim 1, wherein:
said lampshade is composed of an upper cover, a bottom seat and a connecting member for fixing said upper cover and said bottom seat, said upper cover and said bottom seat is formed therebetween a receiving space for receiving said light emitting unit; said upper cover is provided at its center with a transparent sheet for radiating out of light from said light emitting unit.

5. The illuminating device as in claim 4, wherein:
said upper cover is provided on its rear side with a rear engaging portion, an upper edge of said rear side has a rear engaging piece extending upwards, said rear engaging piece presses downwards said rear engaging portion on said upper cover to fix said upper cover onto said rear side of said bottom seat; said upper cover is provided on its front side with a front engaging portion, said bottom seat has a lug extending out of its front side, said lug is excavated to form therein a screw hole for screwing in of a screw; said connecting member has a curved shape and is elastic, one end of it is used for engaging an engaging portion below said lug, another end of it is a pressing portion for press engaging said front engaging portion of said upper cover, said pressing portion is provided with a screw hole for screwing in of a screw, said screw hole is in cooperation with said screw hole on said lug, thereby said screw locks said upper cover and said front side of said bottom seat together.

6. The illuminating device as in claim 4, wherein:
said bottom seat is excavated on its rear side to form a through hole; said electric connector is provided on its top with a fixedly connecting portion, said fixedly connecting portion has a fixedly connecting hole for locking therein with a screw, hence said connector is fixed in said through hole on said rear side of said bottom seat.

7. The illuminating device as in claim 1, wherein:
said elastic buffering portion of each of said plug-in pins on said light emitting unit is in a shape of “U”.

8. The illuminating device as in claim 1, wherein:
said elastic buffering portion of each of said plug-in pins on said light emitting unit is in a shape of “V”.

9. An illuminating unit adapted for installing on an electric connector, said electric connector is connected to an electric power supply to provide electric power for light emitting of said light emitting unit, wherein:
said light emitting unit is composed of a light emitting part and two plug-in pins which include a first and a second plug-in pin, a front half part of each of said first and the second plug-in pins is an arched elastic buffering portion, and a rear half part of each of said plug-in pins is a fixing portion for fixing, said first and second plug-in pins are inserted in said electric connector to electrically connect thereto, a light emitting part thus is provided with electric power for light emitting via said first and second plug-in pins.

10. The illuminating device as in claim 9, wherein:
said electric connector is provided in opposition to said light emitting unit with an insertion connecting portion for insertion of said first and second plug-in pins, and is provided on its two lateral sides with fixing holes being provided on said fixing portions respectively of said first and the second plug-in pins for inserting and fixing of screws therein.

11. The illuminating device as in claim 9, wherein:
said electric connector is provided on a rear side of an insertion connecting portion with a pair of receiving holes, each of said receiving holes is provided with an electrically conductive member being electrically connected with an electric power line and one of said plug-in pins of said light emitting unit.

12. The illuminating device as in claim 9, wherein:
said elastic buffering portion of each of said first and second plug-in pins on said light emitting unit is in a shape of “U”.

13. The illuminating device as in claim 9, wherein:
said elastic buffering portion of each of said first and second plug-in pins on said light emitting unit is in a shape of “V”.
